(19) United States
(12) Patent Application Publication
(10) Pub. No.: US 2025/0363703 A1
(43) Pub. Date: Nov. 27, 2025

(54) CREATING SIMULATION-READY CLOTHED 3D HUMAN AVATARS FROM TEXT DESCRIPTIONS

(71) Applicant: NVIDIA Corporation, Santa Clara, CA (US)

(72) Inventors: Xueting Li, Sunnyvale, CA (US); Ye Yuan, Santa Clara, CA (US); Umar Iqbal, San Jose, CA (US); Miles Macklin, Auckland (NZ); Jonathan Leaf, Austin, TX (US); Donglai Xiang, San Jose, CA (US); Shalini De Mello, San Francisco, CA (US); Jan Kautz, Lexington, MA (US)

(21) Appl. No.: 18/979,205

(22) Filed: Dec. 12, 2024

Related U.S. Application Data
(60) Provisional application No. 63/650,297, filed on May 21, 2024.
(60) Provisional application No. 63/652,992, filed on May 29, 2024.

(51) Int. Cl. G06T 13/40; G06T 17/20

(52) U.S. Cl. CPC G06T 13/40; G06T 17/20; G06T 2200/04

(57) ABSTRACT

Apparatuses, systems, and techniques for generating a clothed three-dimensional (3D) avatar character from a text prompt and enabling smooth animation through physics or neural simulators. In at least one embodiment, a clothed 3D avatar is generated through body layer modeling and garment layer modeling based on text descriptions. The outputs from the body layer and garment layer modeling are combined to generate an animation-ready, clothed 3D avatar.

### CLAIM OF PRIORITY

This application claims the benefit of U.S. Provisional Application No. 63/650,297, titled “Creating Simulation-Ready Clothed 3D Human Avatars from Text Descriptions,” filed May 21, 2024, and U.S. Provisional Application No. 63/652,992, titled “Creating Simulation-Ready Clothed 3D Human Avatars from Text Descriptions,” filed on May 29, 2024, the entire contents of which are incorporated herein by reference.

### BACKGROUND

Existing text-driven human avatar generation methods either model clothing and human body using a unified geometry, or produce garments that are not easily adaptable for simulation within existing graphics pipelines. The primary challenge lies in representing the garment geometry in a way that allows leveraging established prior knowledge from foundational diffusion models (e.g., stable diffusion), while being simulation-ready using either physics or neural simulators.

### SUMMARY

Embodiments of the present disclosure relate to creating simulation-ready clothed three-dimensional (3D) human avatars from text descriptions. Systems and methods are disclosed that implement a framework for modeling a body layer and a garment layer in separate computing branches, combining 3D Gaussians with a latent space prior learned from a large-scale garment dataset to generate a clothed 3D human avatar from a text prompt, thereby enabling smooth animation through physics or neural simulators.

In at least one embodiment, systems and methods disclosed herein can be utilized to generate clothed 3D avatar characters of various types, including animal characters, humanoid figures, fantasy creatures, robotic forms, plant-inspired designs (e.g., anthropomorphic trees or flowers), or even hybrid creations combining features of multiple categories.

### BRIEF DESCRIPTION OF THE DRAWINGS

The present systems and methods for creating simulation-ready clothed three-dimensional (3D) human avatars from text descriptions are described in detail below with reference to the attached drawing figures, wherein:

FIG. 1A illustrates a block diagram of an example avatar simulation system suitable for use in implementing some embodiments of the present disclosure;

FIG. 1B illustrates two garment templates, in accordance with an embodiment;

FIG. 1C illustrates a flow diagram of a process for the body layer modeling as shown in FIG. 1A, in accordance with an embodiment;

FIG. 1D illustrates a flow diagram of a process for the garment layer modeling as shown in FIG. 1A, in accordance with an embodiment;

FIG. 1E illustrates the outputs of the system shown in FIG. 1A, in comparison with other avatar simulation methods, in accordance with an embodiment;

FIG. 1F illustrates example outputs of the system shown in FIG. 1A, in accordance with an embodiment;

FIG. 2A illustrates a flowchart of a method for performing text-driven avatar simulation, in accordance with an embodiment;

FIG. 2B illustrates a flowchart of a method for model training, in accordance with an embodiment;

FIG. 3A illustrates a flow diagram of a graphics simulation pipeline for avatar simulation, in accordance with an embodiment;

FIG. 3B illustrates the processes involved in the body layer modeling and garment layer modeling, as depicted in FIG. 3A, in accordance with an embodiment;

FIG. 4 illustrates an example parallel processing unit suitable for use in implementing some embodiments of the present disclosure;

FIG. 5A is a conceptual diagram of a processing system implemented using the PPU of FIG. 4, suitable for use in implementing some embodiments of the present disclosure;

FIG. 5B illustrates an exemplary system in which the various architecture and/or functionality of the various previous embodiments may be implemented;

FIG. 5C illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

Systems and methods are disclosed herein that relate to creating simulation-ready clothed three-dimensional (3D) human avatars from text descriptions, and in particular, to the enhanced generation of highly realistic, simulation-ready 3D avatars that surpass the capabilities of current approaches.

In at least one embodiment, systems and methods are disclosed that implement an avatar generation framework that generates a clothed 3D human avatar from a text prompt and enables smooth animation through physics-based or neural simulators.

The avatar generation framework utilizes a latent space prior learned from a large-scale garment dataset to regularize garment geometry learning. With this, the avatar generation framework models the avatar using 3D Gaussians that are linked to the latent space prior.

The avatar generation framework predicts an Unsigned Distance Field (UDF) from a learnable garment latent code using an auto-decoder. In at least one embodiment, to regulate garment geometry learning, the opacity of 3D Gaussians is associated with a UDF predicted by a pre-trained garment auto-decoder. For example, auto-decoders from pre-trained models, such as NeuralABC, can be used for predicting a UDF.

In at least one embodiment, the human body and garment are represented using two separate layers of 3D Gaussians. For each 3D Gaussian on the garment, the avatar generation framework queries the 3D Gaussian's unsigned distance to the garment surface from the UDF based on its position. The avatar generation framework then converts the queried distance into opacity through a decreasing function. This design allows for the association of the Gaussians with the garment geometry, as the Gaussians need to be close to the underlying garment surface to achieve meaningful opacity. The flexibility of Gaussians also helps avoid instability often seen in mesh-based approaches due to complex topological changes though optimization in conventional methods.

In at least one embodiment, the avatar generation framework predicts other Gaussian attributes (e.g., color, rotation, and scaling) using an implicit neural field. Along with the Gaussians representing the human body, the avatar generation framework generates a two-dimensional (2D) image of the clothed avatar from a random view through splatting techniques. In at least one embodiment, the avatar generation framework employs diffusion models for supervision using a Score Distillation Sampling (SDS) loss. This approach leverages the flexibility and dense nature of 3D Gaussians to enable knowledge distillation from the foundational diffusion models, while the prior latent space from the avatar generation framework constrains the garment geometry to be within a learned distribution.

In at least one embodiment, to animate the learned garment using a simulator, the avatar generation framework first derives a clean and smooth garment mesh from the corresponding UDF. The avatar generation framework then simulates the garment mesh using either a physics-based or neural simulator given a sequence of body poses. Finally, the avatar generation framework transfers the motion from the animated mesh sequences onto 3D Gaussians through barycentric coordinates.

In least one embodiment, systems and methods disclosed herein can be utilized to generate 3D avatar characters of various types. An avatar character is a digitally generated representation designed to visually embody a wide range of forms, including human or humanoid figures, animals, fantasy creatures, robotic entities, plant-inspired designs (e.g., anthropomorphic trees or flowers), or hybrid creations that combine features from multiple categories. These characters can be clothed and customized to suit various applications, such as gaming, virtual environments, or simulations.

By using 3D Gaussians linked to a latent space prior—facilitated by the UDF predicted from a learned garment latent code—the garment layer can be effectively represented and modeled, leveraging established knowledge from foundational diffusion models. This approach enhances the stability and flexibility of modeling garment surfaces, leading to higher-quality avatars that are more realistic and exhibit fewer defects, thereby enriching the overall avatar design experience. Furthermore, by using a garment mesh derived from the predicted UDF, the resulting representation is simulation-ready, e.g., using physics or neural simulators. This is because simulators require a smooth and clean open mesh for simulation, and the garment meshes provided by the techniques of the present disclosure represent the garment geometries in a smooth and constrained manner. As compared to prior art techniques that provide non-watertight meshes with inflexible topologies, which pose challenges for optimization and constraint, the combination of using 3D Gaussians linked to a latent space prior—facilitated by the UDF predicted from a learned garment latent code—and using garment meshes derived from the predicted UDF enables the creation of animated clothed 3D avatars that are higher quality and more realistic.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

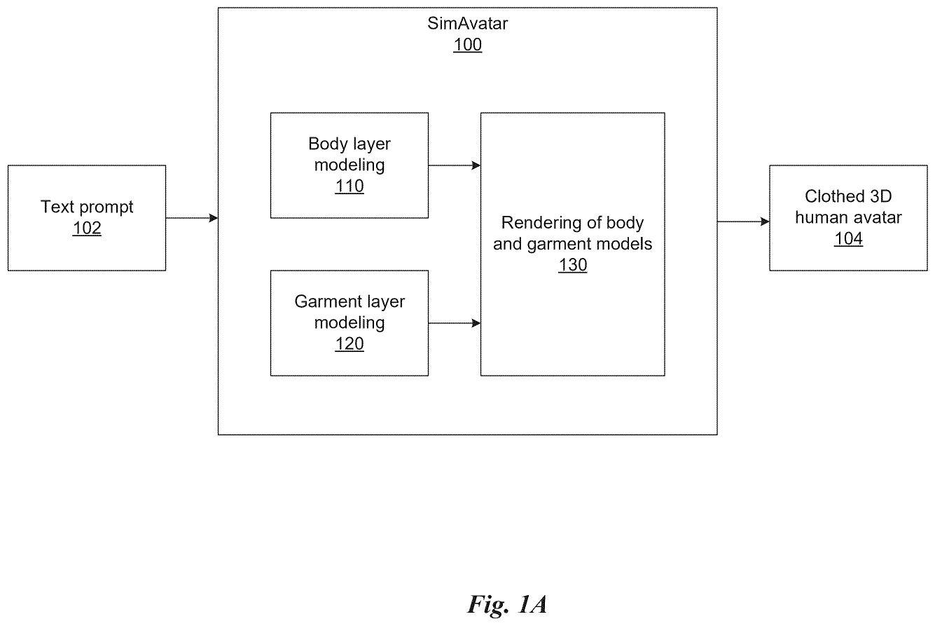

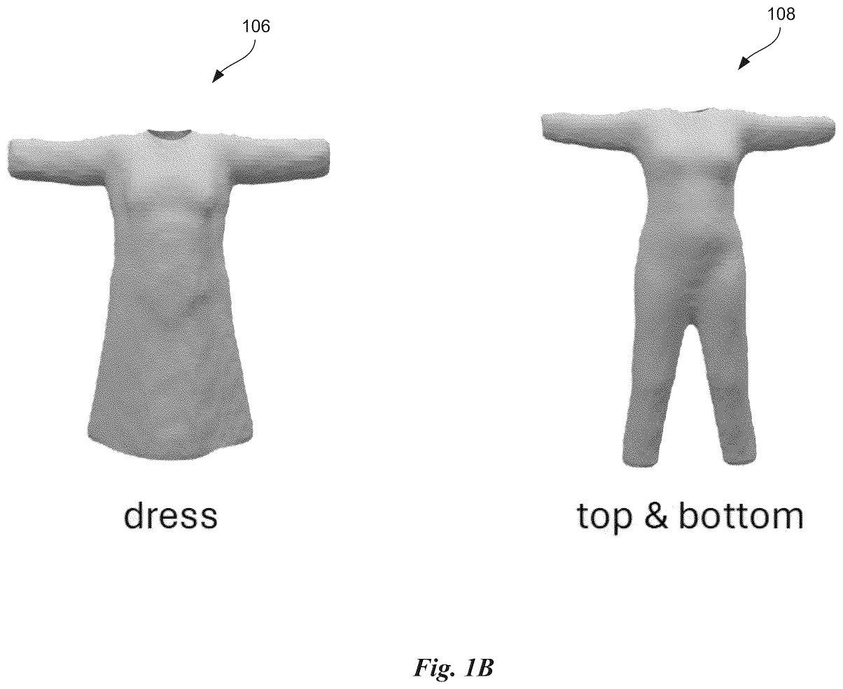

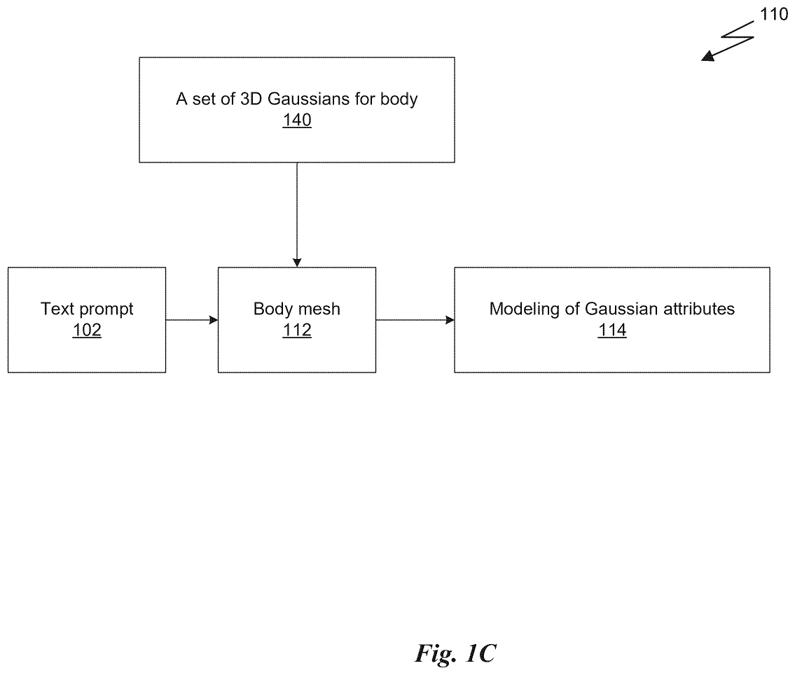

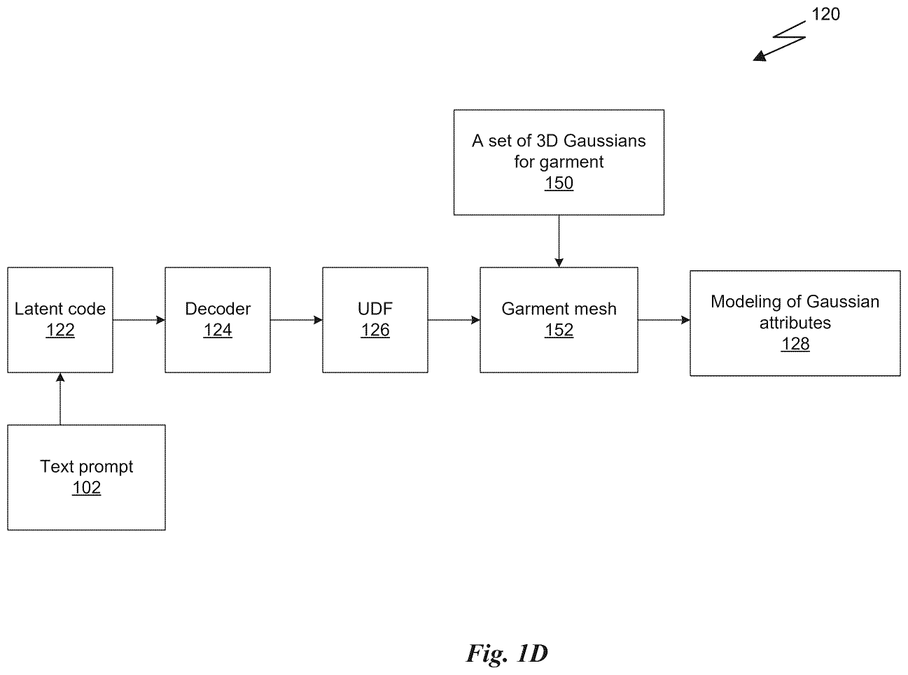

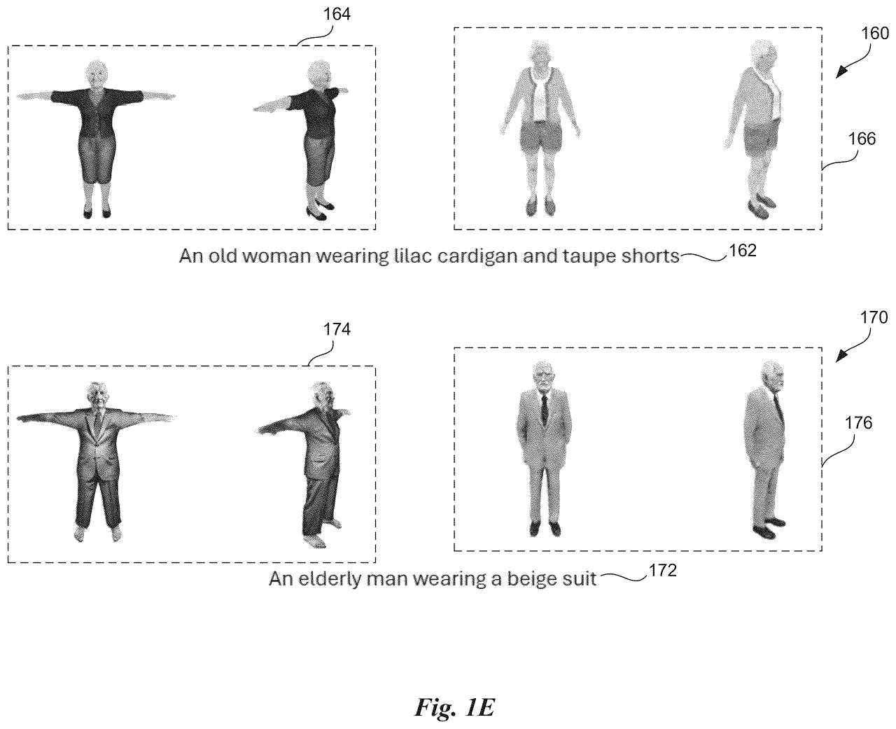

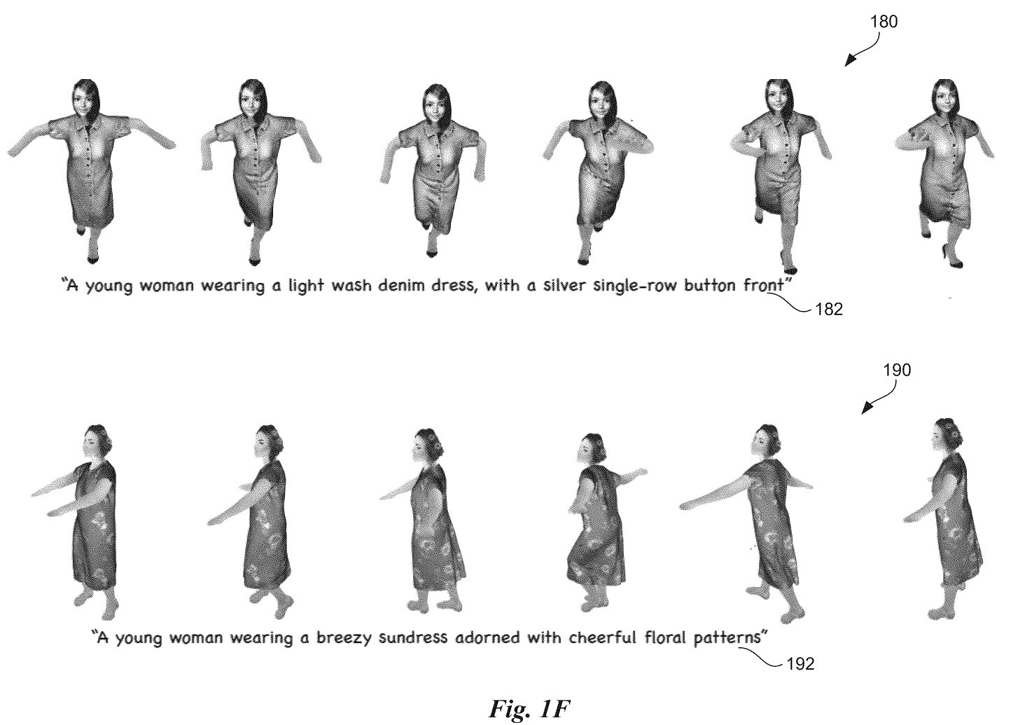

FIG. 1A illustrates a block diagram of an example avatar simulation system 100 suitable for use in implementing some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the avatar simulation system 100 is within the scope and spirit of embodiments of the present disclosure. It is noted that the avatar simulation system 100 is described here with an example of generating clothed 3D human avatars. However, the avatar simulation system 100 is not limited to the generation of 3D human avatars. It can be applied to create various types of avatar figures, including animal characters, humanoid figures, fantasy creatures, robotic forms, plant-inspired designs (e.g., anthropomorphic trees or flowers), and hybrid creations that combine features from multiple categories.

As shown in FIG. 1A, the avatar simulation system 100 (which can be referred to, e.g., as “SimAvatar”) includes various functional modules, including a body layer modeling module 110, a garment layer modeling module 120, and a rendering module 130 for body and garment models. The system 100 implements a framework for avatar simulation, which is referred to as SimAvatar in at least one embodiment.

The system 100 receives a text prompt 102 as an input. The text prompt 102 includes text descriptions for creating a 3D human avatar with a specific clothing. In at least one embodiment, the text descriptions include characteristics of a human body and/or characteristics describing a garment. A garment can consist of a single piece or be made up of distinct parts. Examples of text prompts are provided as follows:

An old woman wearing lilac cardigan and taupe shorts.

An elderly man wearing a beige suit.

A young woman wearing ebony and ivory striped vest and dusty rose shorts.

A young woman wearing a yellow short sleeve dress with flora print.

A young woman wearing a green long sleeve midi shirt dress with animal pattern.

A lady wearing a romantic lace dress with a sweetheart neckline.

A lady wearing a tailored shirt dress.

A young woman wearing grey tweed blazer and charcoal grey trousers.

A young woman wearing a light wash denim dress, with a silver single-row button front.

A young woman wearing a sleeveless lilac dress.

A young woman wearing blue Nike top and black Nike shorts.

A lady wearing a vibrant wrap dress.

A young woman wearing a yellow short sleeve dress with flora print.

An Asian man wearing a Navy Blue Military Jacket and jeans.

A young woman wearing a breezy sundress adorned with cheerful floral patterns.

A young woman wearing mauve vest and dark wash denim jeans.

A young woman wearing dainty floral printed overalls.

In at least one embodiment, the system 100 determines, based on the text prompt 102, a garment template from a collection of garment templates. The system 100 then uses the garment template as an initial garment geometry. FIG. 1B illustrates two garment templates, in accordance with an embodiment. As shown in FIG. 1B, the first garment template 106 visualizes an initial garment geometry for a dress, while the second garment template 108 visualizes an initial garment geometry consisting of a top and bottom pieces.

The system 100 provides as output a clothed 3D human avatar 104 according to the descriptions of a text prompt 102. In at least one embodiment, the system 100 outputs the clothed 3D human avatar 104 based on the results of the body layer modeling 110 and the garment layer modeling 120. In at least one embodiment, the system 100 outputs the clothed 3D human avatar 104 after rendering the body and garment models 130. In at least one embodiment, the system 100 applies lighting modeling to the body and/or garment layers and incorporates a shading effect in the generated clothed 3D human avatar. In at least one embodiment, lighting modeling and/or other suitable modeling can be incorporated in various modes, which the system 100 can be configured to turn on or off for specific applications. In at least one embodiment, the system 100 integrates with or operates in conjunction with an animation simulator to output an animated clothed 3D human avatar.

FIG. 1E illustrates the outputs of the system 100 shown in FIG. 1A, in comparison with other avatar simulation methods, in accordance with an embodiment.

In one example, as indicated by 160, the system 100 generates, based on a text prompt 162, a clothed 3D human avatar in various views. In dashed box 164, the clothed 3D human avatar is displayed in both front and oblique side views, featuring a shading effect that highlights details such as wrinkles in the garment. In contrast, dashed box 166 shows avatars generated by another avatar generation model utilizing existing technology for comparison, also presented in both front and oblique side views. This comparison demonstrates the superior realism achieved by the system 100 in depicting the 3D human avatar dressed in the specified garment. Additionally, as indicated by 170, the system 100 generates another clothed 3D human avatar based on a text prompt 172, presented in both front and oblique side views in dashed box 174, with a similar comparison shown in dashed box 176.

FIG. 1F illustrates example outputs of the system 100, in accordance with an embodiment. For example, as indicated by 180 and 190, the system 100 generates clothed 3D human avatars in a sequence of motions based on text prompts 182 and 192, respectively.

In at least one embodiment, the system 100 is configured to perform modeling on two layers based on the input 102, including the body layer modeling 110 and the garment layer modeling 120, and to render the body and garment models (in block 130) to generate the output 104.

In at least one embodiment, the system 100 performs the body layer modeling 110 based on a body mesh and a set of 3D Gaussians representing the body layer, with the set of 3D Gaussians corresponding to sampling taken from the body mesh.

In at least one embodiment, the system 100 performs the garment layer modeling 120 based on a garment mesh and a set of 3D Gaussians representing the garment layer, with the set of 3D Gaussians corresponding to sampling taken from the garment mesh. In at least one embodiment, the system 100 utilizes one or more neural network models to predict a garment mesh based on the text prompt 102 and/or generate an animated garment mesh.

The system 100 performs rendering of the body and garment models 130 to generate the output 104. In at least one embodiment, the system 100 splatters (or projects) the 3D Gaussians from the body layer modeling 110 and/or the garment layer modeling 120 onto a two-dimensional (2D) image plane during rendering, producing a smooth and detailed image of the clothed 3D human avatar. Additionally and/or alternatively, the system 100 combines the modeled body and garment layers, for example, by superposing the garment layer onto the body layer.

In at least one embodiment, additional effects, such as shading and wrinkling, can be simulated and added during this step. For example, the system 100 can employs a shading model to simulate lighting. Lighting plays an important role in modeling appearance details in motion such as garment wrinkles. To encourage the 3D Gaussians to capture pose-independent albedo without baked-in shading, the system 100 can incorporate a shading model into the avatar simulation/generation pipeline. Since the normal for each Gaussian is noisy, the normal of its corresponding face (denoted as nₚ) can be used in the lighting model. To mimic random lighting, the system 100 samples the point light position (denoted as lₚ∈ [symbol] ³), color (denoted as l_{c}∈ [symbol] ³), as well as an ambient light color (denoted as lₐ∈ [symbol] ³). The shaded color of each 3D Gaussian can then be computed by

$${c}_{i}^{{g}^{′}} = {c}_{i}^{g} \cdot ( max ( 0 , {n}_{p} \cdot \frac{{l}_{p} - {\hat{p}}_{i}^{g}}{‖ {l}_{p} - {\hat{p}}_{i}^{g} ‖} ) \cdot {l}_{c} + {l}_{a} ) .$$

FIG. 1C illustrates a flow diagram of a process for the body layer modeling 110 as shown in FIG. 1A, in accordance with an embodiment. Each block of process 110, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. In addition, process 110 is described, by way of example, with respect to the system of FIG. 1A. However, this process may additionally or alternatively be executed by any one system, or any combination of systems, including, but not limited to, those described herein. Furthermore, persons of ordinary skill in the art will understand that any system that performs process 110 is within the scope and spirit of embodiments of the present disclosure.

In the body layer modeling 110, the system 100 generates a body mesh 112 based on the text prompt 102. In at least one embodiment, the system generates a human body representation by utilizing a Skinned Multi-Person Linear model (SMPL) mesh (Ω), represented by:

$$Ω = LBS ( θ , β ) , \qquad ( Eq . 1 )$$

where θ and β are the SMPL pose and shape parameters, and LBS is the linear blend skinning function. The system 100 can determine the pose and shape parameters (e.g., θ and β) based on the text prompt 102.

At block 140, the system 100 attaches a set of 3D Gaussians for body to the body mesh 112. In at least one embodiment, the system 100 samples a plurality of points on the mesh surface of the body mesh 112 and attaches the set of 3D Gaussians for body to the sampled points. This approach enables flexible geometry and photorealistic appearance modeling. For example, the set of 3D Gaussians for body are represented by

$$\{ {G}_{1}^{b} , … , {G}_{N}^{b} \} ,$$

where N is the total number of Gaussians in the set. Each Gaussian

$${G}_{i}^{b} ,$$

where i∈[1, N] is associated with a face (fⱼ) of the mesh (Ω) and is formulated as:

$${G}_{i}^{b} = \{ {p}_{i}^{b} , {r}_{i}^{b} , {s}_{i}^{b} , {c}_{i}^{b} , {σ}_{i}^{b} \} , \qquad ( Eq . 2 )$$

where

$${p}_{i}^{b} ∈ {ℝ}^{3}$$

represents position,

$${r}_{i}^{b} ∈ {ℝ}^{3}$$

represents rotation,

$${s}_{i}^{b} ∈ {ℝ}^{3}$$

represents scaling,

$${c}_{i}^{b} ∈ {ℝ}^{{d}_{c}}$$

represents color features, and

$${σ}_{i}^{b}$$

represents opacity. Each face (fⱼ) of the mesh (Ω) corresponds to a sampling point from the mesh. The face's (fⱼ) local coordinate is defined as {P(θ), R(θ), γ(θ)}, where P(θ) represents the origin, R(θ) represents rotation, and γ(θ) is a scalar. The origin P(θ)∈ [symbol] ³ is computed as the mean position of the face vertices. The rotation matrix R(θ)∈ [symbol] ^{3×3} is formed by concatenating one edge vector of the face, the normal vector, and their cross product. The scalar γ(θ) is computed as the mean length of the edges. The system 100 obtains the global Gaussian position, rotation, and scale

$$\{ {\hat{p}}_{i}^{b} , {\hat{r}}_{i}^{b} , {\hat{s}}_{i}^{b} \}$$

by applying the local-to-global transform

$$( {b}^{} ( {p}_{i}^{b} , {r}_{i}^{b} , {s}_{i}^{b} ) ) :$$

$${\hat{p}}_{i}^{b} ( θ ) = γ R ( θ ) \cdot {p}_{i}^{b} + P , \qquad ( Eq . 3 a )$$

$${\hat{r}}_{i}^{b} = R ( θ ) \cdot {r}_{i}^{b} , \qquad ( Eq . 3 b )$$

$${\hat{s}}_{i}^{b} = γ ( θ ) {s}_{i}^{b} . \qquad ( Eq . 3 c )$$

In at least one embodiment, the system 100 initializes the 3D Gaussians by uniformly sampling points on the mesh surface and maintains the face correspondences through the Gaussian densification process.

At block 114, the system 100 models/optimizes attributes for each Gaussian of the set of 3D Gaussians for the body 140. In at least one embodiment, the system 100 uses an implicit field

$$( {ℋ}_{ϕ}^{b} )$$

with parameters (ϕ) to model the Gaussian attributes. The system 100 queries the color

$$( {c}_{i}^{b} ) ,$$

opacity

$$( {σ}_{i}^{b} ) ,$$

rotation

$$( {r}_{i}^{b} ) ,$$

and scaling

$$( {s}_{i}^{b} )$$

of each Gaussian using the global Gaussian position

$$( {\hat{p}}_{i}^{b} ( \tilde{θ} ) )$$

under a canonical pose (\tilde{θ}).

$$( {c}_{i}^{b} , {σ}_{i}^{b} , {r}_{i}^{b} , {s}_{i}^{b} ) = {ℋ}_{ϕ}^{b} ( {\hat{p}}_{i}^{b} ( \tilde{θ} ) ) . \qquad ( Eq . 4 )$$

FIG. 1D illustrates a flow diagram of a process for the garment layer modeling 120 as shown in FIG. 1A, in accordance with an embodiment. Each block of process 120, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. In addition, process 120 is described, by way of example, with respect to the system of FIG. 1A. However, this process may additionally or alternatively be executed by any one system, or any combination of systems, including, but not limited to, those described herein. Furthermore, persons of ordinary skill in the art will understand that any system that performs process 120 is within the scope and spirit of embodiments of the present disclosure.

The system 100 obtains a latent code 122 from a garment dataset based on the description of the garment from the text prompt 102. In at least one embodiment, the latent code 122 is a garment template selected from a collection of garment templates based on the text prompt 102. The system 100 decodes, via a pre-trained decoder 124, the latent code 122 to predict an unsigned distance field (UDF) 126 based on the latent code 122. The system 100 obtains a garment mesh 152 based on the UDF 126. The unsigned distance field (UDF) 126 includes a plurality of unsigned distances, each unsigned distance corresponding to a location in the 3D space.

At block 150, the system 100 attaches a set of 3D Gaussians for garment to a plurality of points sampled on the garment mesh 152. At block 128, the system 100 models/optimizes attributes for each Gaussian of the set of 3D Gaussians for the garment 150.

The system 100 combines 3D Gaussians with UDFs sampled from a latent space learned from a garment dataset. In at least one embodiment, a learnable latent code (l) 122 is used to represent the underline garment geometry. The system 100 uses a pre-trained decoder 124 to predict a corresponding UDF 126. A set of 3D Gaussians for garment are represented by

$$\{ {G}_{1}^{g} , … , {G}_{M}^{g} \} ,$$

where M is the total number of Gaussians in the set. Each Gaussian

$${G}_{i}^{g} ,$$

where i∈[1, M], is defined as:

$${G}_{i}^{g} = \{ {p}_{i}^{g} , {r}_{i}^{g} , {s}_{i}^{g} , {c}_{i}^{g} , {σ}_{i}^{g} \} , \qquad ( Eq . 5 )$$

similar to the body Gaussians,

$${p}_{i}^{g} ∈ {ℝ}^{3}$$

represents position,

$${r}_{i}^{g} ∈ {ℝ}^{3}$$

represents rotation

$${s}_{i}^{g} ∈ {ℝ}^{3}$$

represents scaling

$${c}_{i}^{g} ∈ {ℝ}^{{d}_{c}}$$

represents color features, and

$${σ}_{i}^{g}$$

represents opacity. The garment Gaussians can be driven by the mesh extracted from the UDF 126 using a local-to-global transform

$$( {g}^{} ( {p}_{i}^{g} , {r}_{i}^{g} , {s}_{i}^{g} ) ) :$$

$${\hat{p}}_{i}^{g} ( θ ) = γ R ( θ ) \cdot {p}_{i}^{g} + P , \qquad ( Eq . 6 a )$$

$${\hat{r}}_{i}^{g} = R ( θ ) \cdot {r}_{i}^{g} , \qquad ( Eq . 6 b )$$

$${\hat{s}}_{i}^{g} = γ ( θ ) {s}_{i}^{g} . \qquad ( Eq . 6 c )$$

The system 100 queries the unsigned distance

$$( {d}_{u} ( {\hat{p}}_{i}^{g} ) )$$

for each Gaussian

$$( {G}_{i}^{g} )$$

at position

$$( {\hat{p}}_{i}^{g} )$$

as:

$${d}_{u} ( {\hat{p}}_{i}^{g} ) = {D}_{garment} ( {\hat{p}}_{i}^{g} , l ) , \qquad ( Eq . 7 a )$$

where D_{garment}( ) represents a pre-trained decoder. The pre-trained decoder (D_{garment}) takes a latent code (l) and a query point

$$( e . g . , {\hat{p}}_{i}^{g} )$$

as inputs anu outputs an unsigned distance

$$( e . g . , {d}_{u} ( {\hat{p}}_{i}^{g} ) )$$

of the queried point. The output unsigned distance is the distance from the location in the 3D space to the nearest garment surface (e.g., the garment mesh 152) for the Gaussian

$$( {G}_{i}^{g} ) .$$

The system 100 then converts the unsigned distance

$$( {d}_{u} ( {\hat{p}}_{i}^{g} ) )$$

to opacity

$$( {σ}_{i}^{g} )$$

through a decreasing function:

$$𝒦 ( x ) = \frac{γ {e}^{- λ x}}{{( 1 + {e}^{- λ x} )}^{2}} , x > 0. \qquad ( Eq . 7 b )$$

This approach links the 3D Gaussians with the garment surface (e.g., the garment mesh 152) and the predicted UDF 126.

The system 100 learns an implicit field

$$( {ℋ}_{ψ}^{g} )$$

with parameters (ψ) to predict additional attributes of the 3D Gaussians attached to the garment, including color

$$( {c}_{i}^{g} )$$

rotation

$$( {r}_{i}^{g} ) ,$$

and scaling

$$( {s}_{i}^{g} ) .$$

The implicit field

$$( {ℋ}_{ψ}^{g} )$$

can also be defined under the canonical garment pose (\tilde{θ}). Formally, the opacity

$$( {σ}_{i}^{g} )$$

is obtained through

$${σ}_{i}^{g} = 𝒦 ( {D}_{garment} ( {\hat{p}}_{i}^{g} ( \tilde{θ} ) , l ) ) \qquad ( Eq . 8 a )$$

The attributes of the Gaussians are updated as:

$$( {c}_{i}^{g} , {r}_{i}^{g} , {s}_{i}^{g} ) = {ℋ}_{ψ}^{g} ( {\hat{p}}_{i}^{g} ( \tilde{θ} ) ) . \qquad ( Eq . 8 b )$$

The UDF 126 predicted from a latent code 122 within a smooth space provides regularization for garment geometry learning. In contrast, technologies that remove such constraint (i.e., using 3D Gaussians alone to represent garment geometry) often lead to entanglement of garment geometry and texture, as well as artifacts such as holes or tears. Additionally, this naive approach (i.e., without the constraint) poses a non-trivial optimization challenge and often leads to suboptimal results. This is likely due to the complex topological changes in the mesh and the noisy supervision from foundational diffusion models, which cannot consistently guide the latent code in the correct direction at every optimization step.

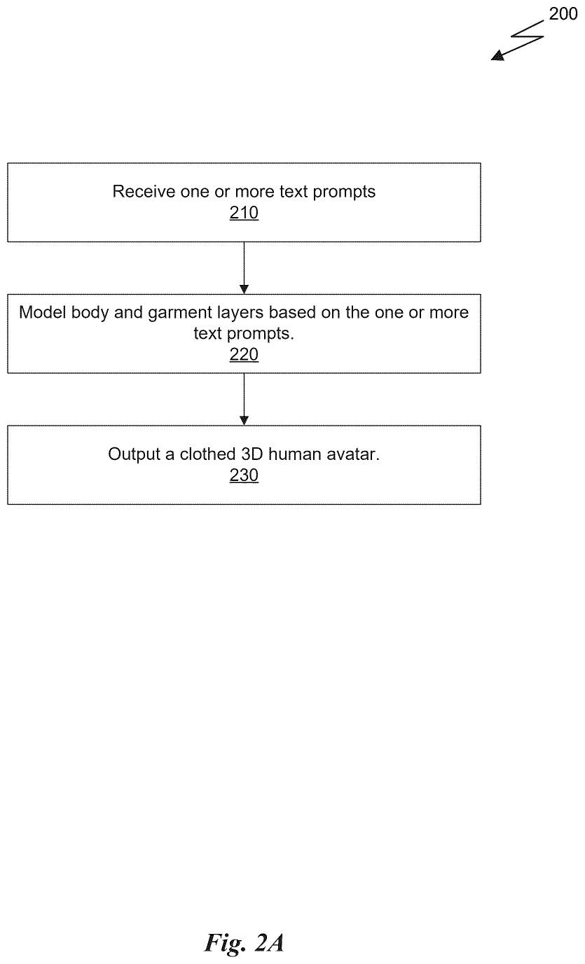

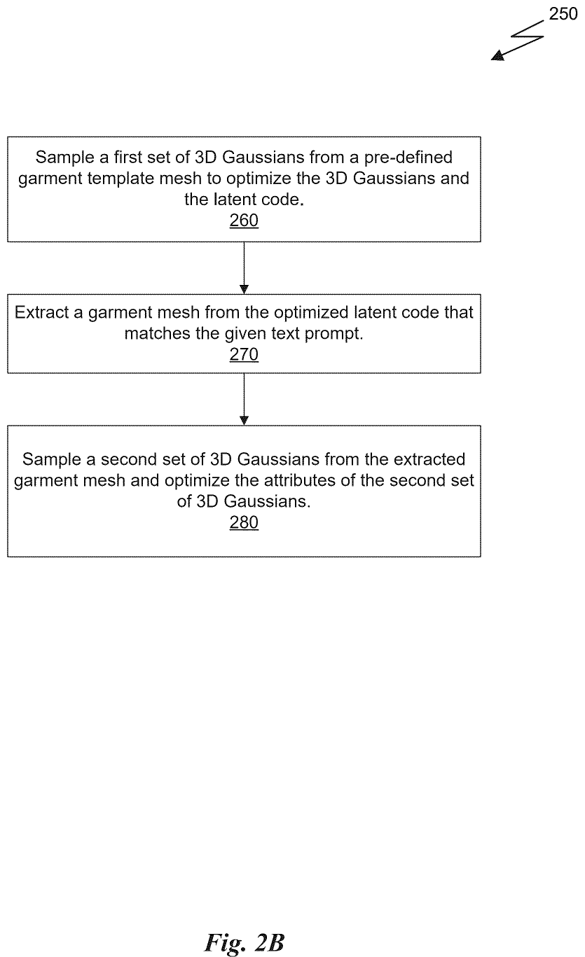

FIG. 2A illustrates a flowchart of a method 200 for performing text-driven avatar simulation, in accordance with an embodiment. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 200 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

It is noted that the method 200 is described here using an example of generating clothed 3D human avatars. However, the method 200 is not limited to the generation of 3D human avatars. It can also be applied to create various types of avatar figures, including animal characters, humanoid figures, fantasy creatures, robotic forms, plant-inspired designs (e.g., anthropomorphic trees or flowers), and hybrid creations that combine features from multiple categories.

At block 210, the system 100 receives one or more text prompts 102.

At block 220, the system 100 models body and garment layers (e.g., in blocks 110 and 120) based on the one or more text prompts 102. The body layer can be modeled utilizing the process as depicted in FIG. 1C. The garment layer can be modeled utilizing the process as depicted in FIG. 1D. The modeling of the body layer and the garment layer can be performed in parallel, sequentially, or in a hybrid manner. In at least one embodiment, the system 100 renders the body and garment models (e.g., in block 130). In at least one embodiment, image rendering techniques, such as Gaussian splattering, can be utilized to enhance the realism and visual appeal of the avatar, for example, by applying smooth transitions and blending effects. The 3D Gaussians can be splatted (or projected) onto a two-dimensional (2D) image plane during rendering, producing a smooth and detailed image of the clothed 3D human avatar. Additionally and/or alternatively, this step combines the modeled body and garment layers, for example, by superposing the garment layer onto the body layer. In at least one embodiment, additional effects, such as shading and wrinkling, can be simulated and added during this step.

At block 230, the system 100 outputs a clothed 3D human avatar (e.g., in block 104). The clothed 3D human avatar is animation ready. In at least one embodiment, the system outputs an animated clothed 3D human avatar.

FIG. 2B illustrates a flowchart of a method 250 for model training, in accordance with an embodiment. Each block of method 250, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 250 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 250 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

It is noted that the method 250 is described here using an example of generating clothed 3D human avatars. However, the method 250 is not limited to the generation of 3D human avatars. It can also be applied to create various types of avatar figures, including animal characters, humanoid figures, fantasy creatures, robotic forms, plant-inspired designs (e.g., anthropomorphic trees or flowers), and hybrid creations that combine features from multiple categories.

A Score Distillation Sampling (SDS) objective with a pre-trained text-to-image diffusion model is utilized to supervise the Gaussian splatting-based rendering (I(η)) of the body and garment modeling, where η denotes all learnable parameters. Given a text prompt y and the noise prediction \hat{ϵ} (Iₜ; y, t) of the diffusion model, SDS optimizes parameters (η) by minimizing the difference between the noise (ϵ) added to the rendered image (through the Gaussian splatting-based rendering process I(η)) and the predicted noise (ϵ) by the diffusion model, formulated as:

$${∇}_{η} {ℒ}_{SDS} = {E}_{t , ϵ} [ ω ( t ) ( \hat{ϵ} ( {I}_{t} ; y , t ) - ϵ ) \frac{\partial I}{\partial η} ] , \qquad ( Eq . 9 )$$

where t is the noise level, Iₜ is the noised image, and ω(t) is a weighing function. Additionally, to prevent the Gaussians from straying far away from its associated mesh face, a local position regularization loss ( [symbol] ₚₒₛ) is utilized, formulated as:

$${ℒ}_{pos} = {\sum }_{i} {‖ {p}_{i}^{b} ‖}^{2} + {\sum }_{i} {‖ {p}_{i}^{g} ‖}^{2} . \qquad ( Eq . 10 )$$

The overall training objective is defined as:

$$ℒ = {ℒ}_{SDS} + {λℒ}_{pos} \qquad ( Eq . 11 )$$

where λ is a weighting factor.

The system 100 utilizes the method 250 and the aforementioned objective and/or loss functions to optimize the model in the system through a two-step training scheme. This training enhances the capability of system 100 to predict an accurate garment mesh (e.g., the garment mesh 152 as shown in FIG. 1D) based on a latent code (e.g., the latent code 122 as shown in FIG. 1D) derived from a text prompt (e.g., the text prompt 102 as shown in FIG. 1D).

At block 260, the system 100 samples a first set of 3D Gaussians from a pre-defined garment template mesh to optimize the 3D Gaussians and the latent code.

At block 270, the system 100 extracts a garment mesh from the optimized latent code. The extracted garment mesh matches the given text prompt.

At block 280, the system 100 samples a second set of 3D Gaussians from the garment mesh from block 270 and optimizes the attributes of the second set of 3D Gaussians.

In at least one embodiment, the size of the first set of 3D Gaussians is less than or equal to the size of the second set of 3D Gaussians.

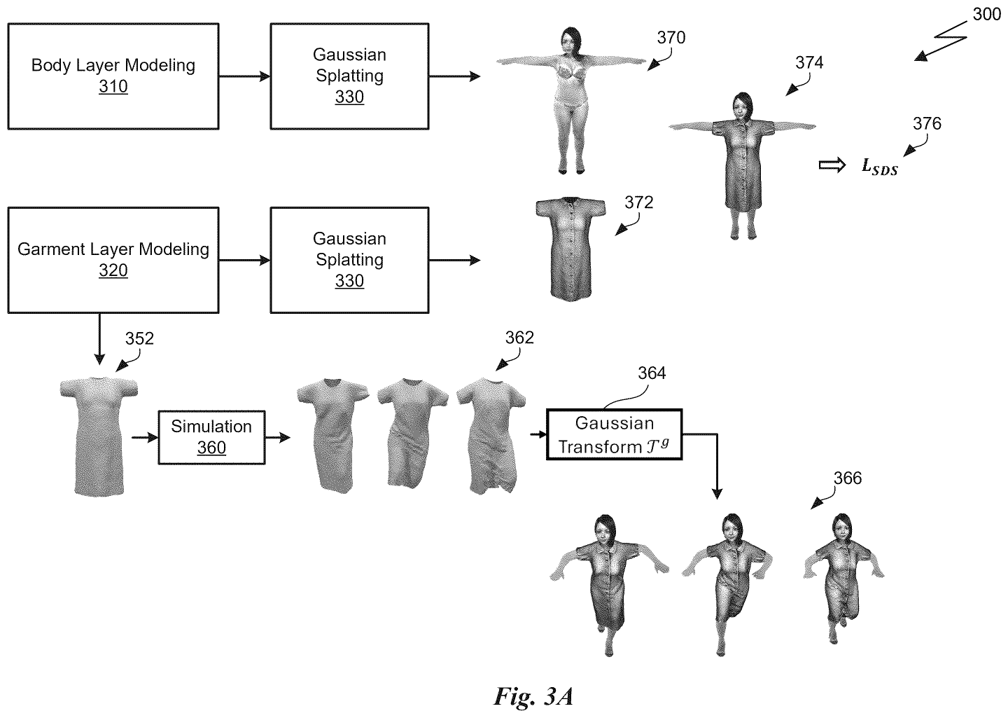

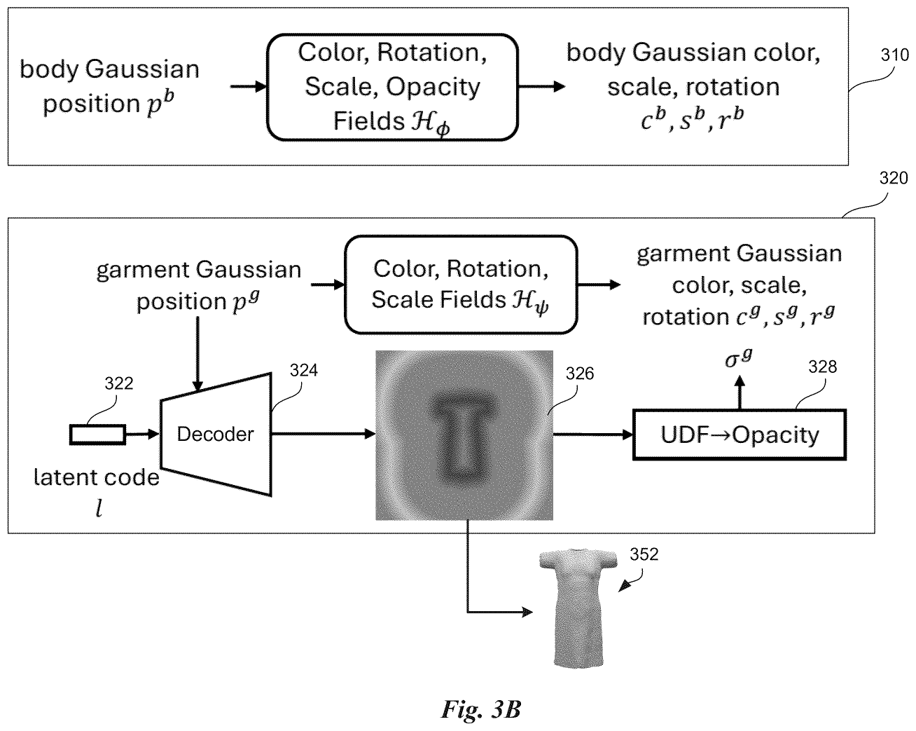

FIG. 3A illustrates a flow diagram of a graphics simulation pipeline 300 for avatar simulation, in accordance with an embodiment. Each block of pipeline 300, described herein, comprises a computing process that may be performed using any combination of hardware, firmware, and/or software. For instance, various functions may be carried out by a processor executing instructions stored in memory. The pipeline may also be embodied as computer-usable instructions stored on computer storage media. The pipeline may be provided by a standalone application, a service or hosted service (standalone or in combination with another hosted service), or a plug-in to another product, to name a few. In addition, pipeline 300 is described, by way of example, with respect to the system of FIG. 1A. However, this pipeline may additionally or alternatively be executed by any one system, or any combination of systems, including, but not limited to, those described herein. Furthermore, persons of ordinary skill in the art will understand that any system that performs pipeline 300 is within the scope and spirit of embodiments of the present disclosure.

More illustrative information will now be set forth regarding various optional architectures and features with which the foregoing pipeline may be implemented, per the desires of the user. It should be strongly noted that the following information is set forth for illustrative purposes and should not be construed as limiting in any manner. Any of the following features may be optionally incorporated with or without the exclusion of other features described.

It is noted that the pipeline 300 is described here using an example of generating clothed 3D human avatars. However, the pipeline 300 is not limited to the generation of 3D human avatars. It can also be applied to create various types of avatar figures, including animal characters, humanoid figures, fantasy creatures, robotic forms, plant-inspired designs (e.g., anthropomorphic trees or flowers), and hybrid creations that combine features from multiple categories.

The pipeline 300 employs parallel computing branches to model the body layer (e.g., in block 310) and the garment layer (e.g., in block 320). By executing the pipeline 300, the system 100 generates a 3D human avatar model via the body layer modeling 310 and a 3D garment model via the garment layer modeling 320. The system 100 applies Gaussian splattering 330 to the outputs of the body layer modeling 310 and the garment layer modeling 320, generating a 2D image of the human avatar 370 and a 2D image of the garment 372, respectively. The system 100 can combine the 2D image of the human avatar 370 and the 2D image of the garment 372 to generate a 2D image of a clothed human avatar 374. As discussed above, during training, the system 100 can calculate the SDS loss ( [symbol] _{SDS}) based on the 2D image of a clothed human avatar 374 and updates the model (e.g., one or more learnable parameters in the system 100) utilizing the SDS loss, for example by applying Equations 9-11.

Additionally, the system 100 can animate the garment based on an output from the garment layer modeling 320. The system 100 obtains a mesh 352 from the UDF generated in the garment layer modeling 320. The system 100 can drive the mesh 352 by using a simulator to perform simulation 360 for garment animation. In at least one embodiment, the simulator can be a physics-based or neural simulator. The physics-based simulator applies real-world physics to simulate garment movement and deformation, ensuring realistic behavior in response to the avatar's motion. Alternatively, a neural simulator can leverage machine learning models to predict garment dynamics, offering a more computationally efficient approach while still achieving visually accurate results. With simulation 360, the system 100 generates a sequence of animated garment meshes corresponding to a sequence of target human poses.

For example, the garment mesh 352 is represented as [symbol] =(V, F), where V denotes the set of vertices and F denotes the set of faces. The garment mesh 352 is derived from the UDF (e.g., 326 as shown in FIG. 3B). A sequence of target human poses are denoted as {θ₁, . . . , θ_{T}}, and a sequence of animated garment meshes are denoted as { [symbol] ₁, . . . , [symbol] _{T}}. In at least one embodiment, the system 100 employs a learned graph neural network to predict the animated garment meshes { [symbol] ₁, . . . , [symbol] _{T}}. Using the simulated garment mesh sequence, the system 100 can apply the local-to-global transform process [symbol] ^{g} (e.g., with Equations 6a-6c), as indicated in block 364, to animate the 3D garment Gaussians. The system 100 can then combine the target human poses {θ₁, . . . , θ_{T}} and the animated garment meshes 362 and/or the transformed 3D garment Gaussians to generate a sequence of clothed human avatars 366.

FIG. 3B illustrates the processes involved in the body layer modeling 310 and garment layer modeling 320, as depicted in FIG. 3A, in accordance with an embodiment. Each process in the body layer modeling 310 and garment layer modeling 320, described herein, comprises a computing process that may be performed using any combination of hardware, firmware, and/or software. For instance, various functions may be carried out by a processor executing instructions stored in memory. The processes may also be embodied as computer-usable instructions stored on computer storage media. The processes may be provided by a standalone application, a service or hosted service (standalone or in combination with another hosted service), or a plug-in to another product, to name a few. In addition, the processes are described, by way of example, with respect to the system of FIG. 1A. However, the processes may additionally or alternatively be executed by any one system, or any combination of systems, including, but not limited to, those described herein. Furthermore, persons of ordinary skill in the art will understand that any system that performs the processes is within the scope and spirit of embodiments of the present disclosure.

At block 310, the system 100 obtains a set of body Gaussians associated with a plurality of body Gaussian positions (p^{b}), applies an implicit field ( [symbol] _{ϕ}) with parameters (ϕ) to model the Gaussian attributes, and subsequently obtains the corresponding body Gaussian attributes, such as color (c^{b}), scale (s^{b}), and rotation (r^{b}). In at least one embodiment, the system 100 executes the process 110, as shown in FIG. 1C, to carry out the body layer modeling 310. The body layer modeling 310 can involve computing one or more of the equations from Equations 1-4.

At block 320, the system 100 decodes a latent code (l) 322 using a decoder 324 to predict a UDF 326. Similar to the body layer modeling 310, the system 100 obtains a set of garment Gaussians associated with a plurality of garment Gaussian positions (p^{g}), applies an implicit field ( [symbol] _{ψ}) with parameters (ψ) to model the Gaussian attributes, and subsequently obtains the corresponding garment Gaussian attributes, such as color (c^{g}), scale (s^{g}), and rotation (r^{g}). Furthermore, as indicated in block 328, the system 100 generates opacity (σ^{g}) based on the UDF. In at least one embodiment, the system 100 executes the process 120, as shown in FIG. 1D, to carry out the garment layer modeling 320. The garment layer modeling 320 can involve computing one or more of the equations from Equations 5-8. Additionally, the system 100 can generate the garment mesh 352, represented by [symbol] =(V, F), based on the UDF 326 for garment animation, as discussed in reference to FIG. 3A.

In at least one embodiment, the system 100 can utilize one or more pre-trained neural network models. For example, the decoder 324 can employ a pre-trained neural network model, such as NeuralABC. The simulation 360 can employ a pre-trained neural simulator, such as HOOD.

### Parallel Processing Architecture

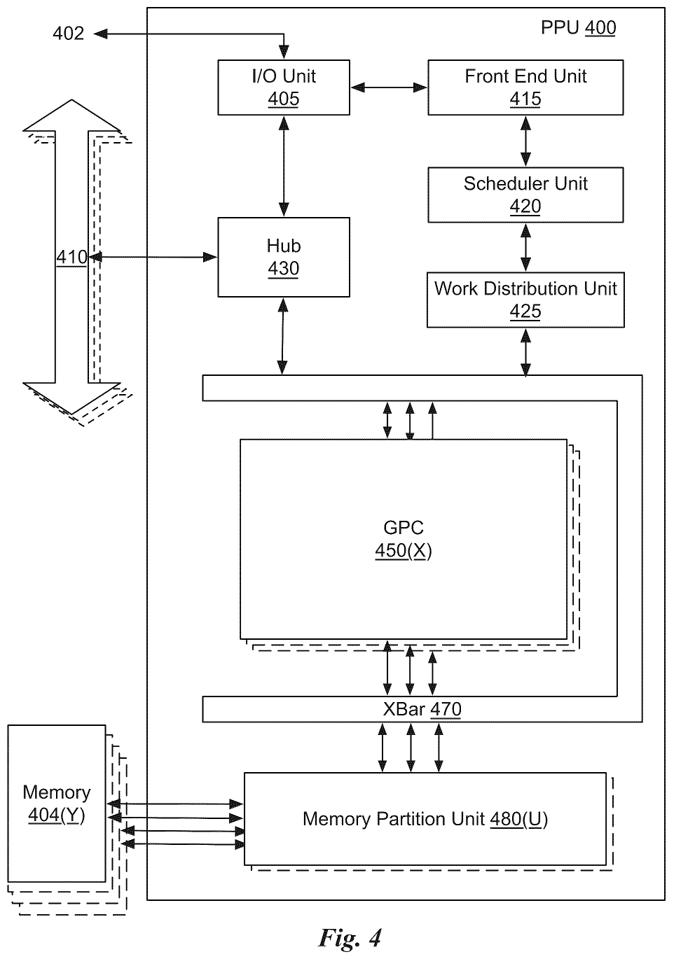

FIG. 4 illustrates a parallel processing unit (PPU) 400, in accordance with an embodiment. In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

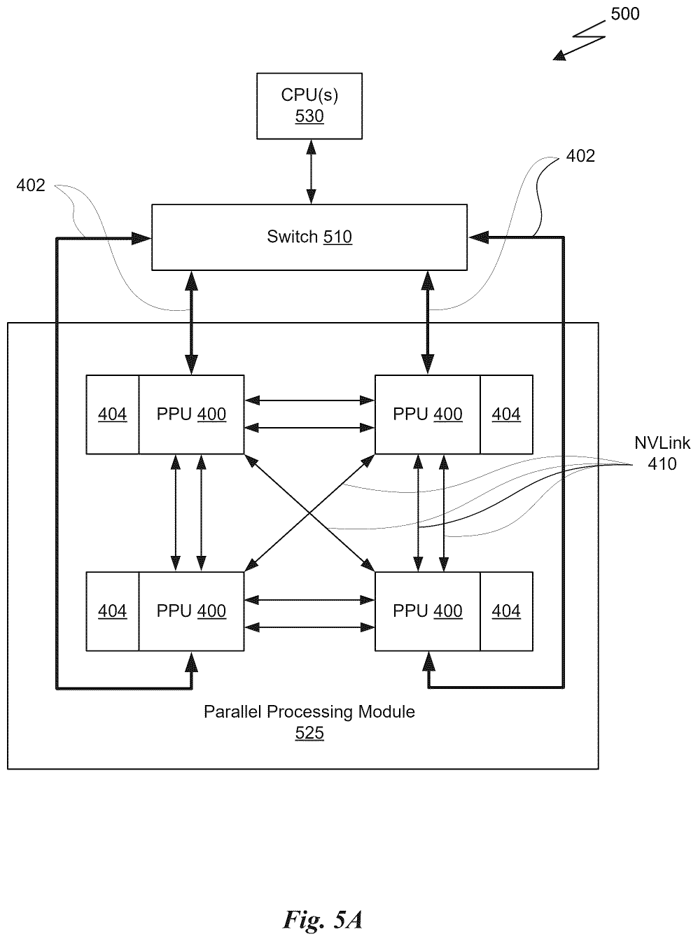

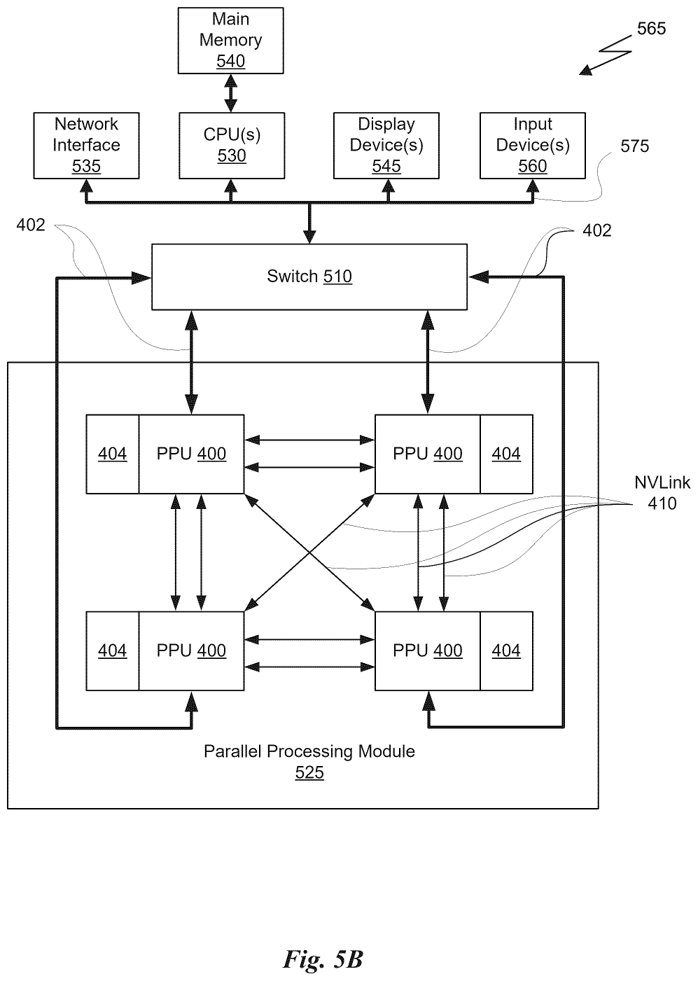

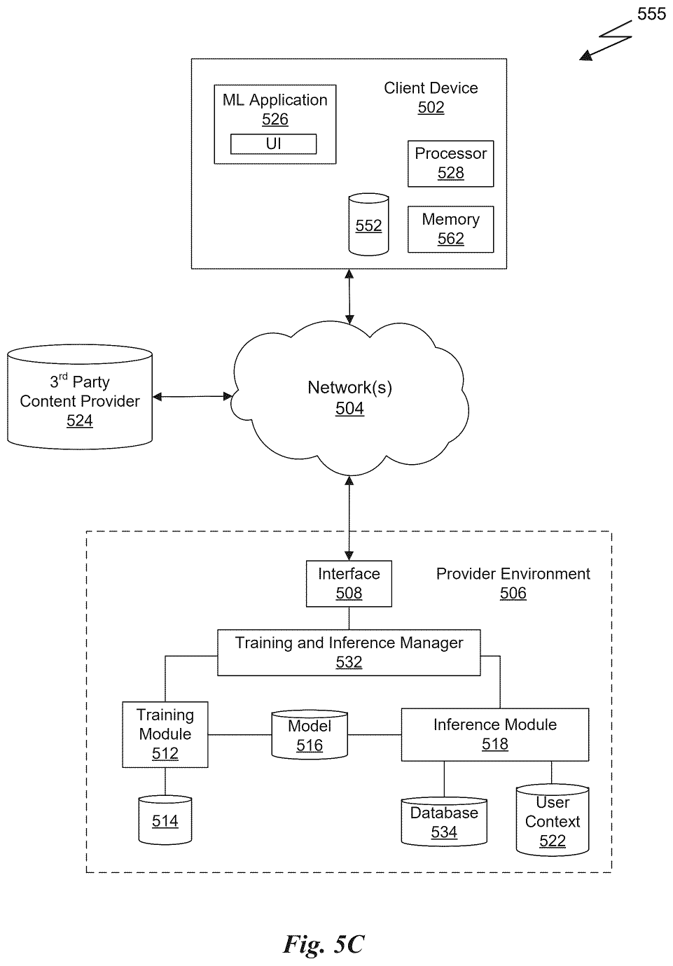

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QOS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache 460 and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

A graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline utilizing the hardware of the PPU 400.

Various programs may be executed within the PPU 400 in order to implement the various stages of the graphics processing pipeline. For example, the device driver may launch a kernel on the PPU 400 to perform a vertex shading stage on one processing unit (or multiple processing units). The device driver (or the initial kernel executed by the PPU 400) may also launch other kernels on the PPU 400 to perform other stages of the graphics processing pipeline, such as a geometry shading stage and a fragment shading stage. In addition, some of the stages of the graphics processing pipeline may be implemented on fixed unit hardware such as a rasterizer or a data assembler implemented within the PPU 400. It will be appreciated that results from one kernel may be processed by one or more intervening fixed function hardware units before being processed by a subsequent kernel on a processing unit.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

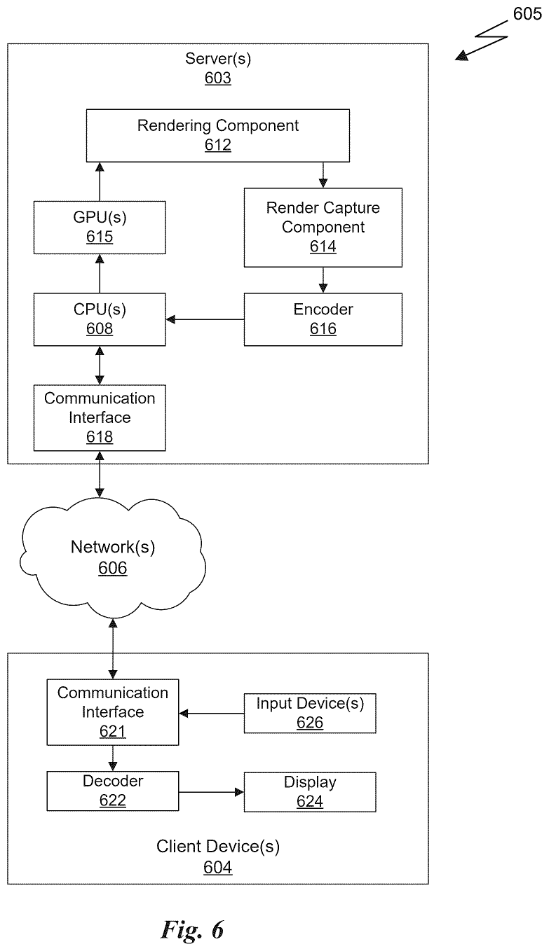

FIG. 6 is an example system diagram for a streaming system 605, in accordance with some embodiments of the present disclosure. FIG. 6B includes game server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s), transmit the input data to the game server(s) 603, receive encoded display data from the game server(s) 603, and display the display data on the display 624. As such, the more computationally intense computing and processing is offloaded to the game server(s) 603 (e.g., rendering—in particular ray or path tracing—for graphical output of the game session is executed by the GPU(s) of the game server(s) 603). In other words, the game session is streamed to the client device(s) 604 from the game server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the game server(s) 603. The client device 604 may receive an input to one of the input device(s) and generate input data in response. The client device 604 may transmit the input data to the game server(s) 603 via the communication interface 621 and over the network(s) 606 (e.g., the Internet), and the game server(s) 603 may receive the input data via the communication interface 618. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the game server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for generating a clothed three-dimensional (3D) avatar, comprising:
receiving one or more text prompts;
modeling, based on the text prompts, a body layer for the clothed 3D avatar;
modeling, based on the text prompts, a garment layer for the clothed 3D avatar;
combining the body layer and the garment layer for the clothed 3D avatar; and
outputting the clothed 3D avatar.

2. The method of claim 1, wherein modeling the body layer for the clothed 3D avatar comprises:
determining, based on the one or more text prompts, a body mesh for the clothed 3D avatar;
modeling a first set of Gaussians corresponding to the body mesh; and
outputting a body model of the clothed 3D avatar.

3. The method of claim 1, wherein modeling the garment layer for the clothed 3D avatar comprises:
determining, based on the one or more text prompts, a latent code corresponding to a garment template;
generating, based on the latent code and using a decoder, an unsigned distance field (UDF) corresponding to the garment layer of the clothed 3D avatar;
modeling a second set of Gaussians corresponding to the UDF; and
outputting a garment model of the clothed 3D avatar.

4. The method of claim 3, wherein the latent code among a plurality of latent codes, wherein the plurality of latent codes correspond to a plurality of garment templates, and wherein the plurality of latent codes and the plurality of garment templates are learned from a garment dataset.

5. The method of claim 3, wherein the UDF comprises a plurality of unsigned distances, the method further comprises:
determining, for each unsigned distance of the plurality of unsigned distances, an opacity value for the respective unsigned distance.

6. The method of claim 3, further comprising:
deriving a garment mesh based on the UDF;
generating, based on the garment mesh, a sequence of garment meshes corresponding to a sequence of poses associated with the clothed 3D avatar; and
generating a third set of Gaussians corresponding to the garment mesh by transforming the second set of Gaussians corresponding to the UDF.

7. The method of claim 3, further comprising:
training the generation of latent code and 3D Gaussians,
wherein the training comprises:
sampling a fourth set of 3D Gaussians from a pre-defined garment template mesh to optimize the fourth set of 3D Gaussians and a predicted latent code, wherein the predicted latent code corresponds to the pre-defined garment template mesh;
extracting a predicted garment mesh from the optimized latent code; and
sampling a fifth set of 3D Gaussians from the predicted garment mesh to optimize the attributes of the fifth set of 3D Gaussians.

8. The method of claim 1, further comprising:
modeling lighting effects on the garment layer for the clothed 3D avatar.

9. The method of claim 1, wherein modeling the body layer and modeling the garment layer are performed in parallel, in sequence, or in a hybrid manner.

10. The method of claim 1, wherein the clothed 3D avatar is a clothed 3D human avatar.

11. A system for generating a clothed three-dimensional (3D) avatar comprising:
one or more processors configured to:
receive one or more text prompts;
model, based on the text prompts, a body layer for the clothed 3D avatar;
model, based on the text prompts, a garment layer for the clothed 3D avatar;
combine the body layer and the garment layer for the clothed 3D avatar; and
output the clothed 3D avatar.

12. The system of claim 11, wherein modeling the body layer for the clothed 3D avatar comprises:
determining, based on the one or more text prompts, a body mesh for the clothed 3D avatar;
modeling a first set of Gaussians corresponding to the body mesh; and
outputting a body model of the clothed 3D avatar.

13. The system of claim 11, wherein modeling the garment layer for the clothed 3D avatar comprises:
determining, based on the one or more text prompts, a latent code corresponding to a garment template;
generating, based on the latent code and using a decoder, an unsigned distance field (UDF) corresponding to the garment layer of the clothed 3D avatar;
modeling a second set of Gaussians corresponding to the UDF; and
outputting a garment model of the clothed 3D avatar.

14. The system of claim 13, wherein the latent code among a plurality of latent codes, wherein the plurality of latent codes correspond to a plurality of garment templates, and wherein the plurality of latent codes and the plurality of garment templates are learned from a garment dataset.

15. The system of claim 13, wherein the UDF comprises a plurality of unsigned distances, and wherein the one or more processors are further configured to:
determine, for each unsigned distance of the plurality of unsigned distances, an opacity value for the respective unsigned distance.

16. The system of claim 13, wherein the one or more processors are further configured to:
derive a garment mesh based on the UDF;
generate, based on the garment mesh, a sequence of garment meshes corresponding to a sequence of poses associated with the clothed 3D avatar; and
generate a third set of Gaussians corresponding to the garment mesh by transforming the second set of Gaussians corresponding to the UDF.

17. The system of claim 13, wherein the one or more processors are further configured to:
train the generation of latent code and 3D Gaussians,
wherein the training comprises:
sampling a fourth set of 3D Gaussians from a pre-defined garment template mesh to optimize the fourth set of 3D Gaussians and a predicted latent code, wherein the predicted latent code corresponds to the pre-defined garment template mesh;
extracting a predicted garment mesh from the optimized latent code; and
sampling a fifth set of 3D Gaussians from the predicted garment mesh to optimize the attributes of the fifth set of 3D Gaussians.

18. The system of claim 11, wherein the one or more processors are further configured to:
model lighting effects on the garment layer for the clothed 3D avatar.

19. The system of claim 11, wherein modeling the body layer and modeling the garment layer are performed in parallel, in sequence, or in a hybrid manner.

20. The system of claim 11, wherein the clothed 3D avatar is a clothed 3D human avatar.

21. A machine-readable medium for generating a clothed three-dimensional (3D) avatar, having stored thereon a set of instructions, which if performed by one or more processors, cause the one or more processors to:
receive one or more text prompts;
model, based on the text prompts, a body layer for an avatar corresponding to the clothed 3D avatar;
model, based on the text prompts, a garment layer for the clothed 3D avatar;
combine the body layer and the garment layer for the clothed 3D avatar; and
output the clothed 3D avatar.

22. The machine-readable medium of claim 19,
wherein modeling the body layer for the clothed 3D avatar comprises:
determining, based on the one or more text prompts, a body mesh for the clothed 3D avatar;
modeling a first set of Gaussians corresponding to the body mesh; and
outputting a body model of the clothed 3D avatar, and
wherein modeling the garment layer for the clothed 3D avatar comprises:
determining, based on the one or more text prompts, a latent code corresponding to a garment template;
generating, based on the latent code and using a decoder, an unsigned distance field (UDF) corresponding to the garment layer of the clothed 3D avatar;
modeling a second set of Gaussians corresponding to the UDF; and
outputting a garment model of the clothed 3D avatar.

23. The machine-readable medium of claim 1, wherein the clothed 3D avatar is a clothed 3D human avatar.
